(19) United States
(12) Patent Application Publication
(10) Pub. No.: US 2026/0320041 A1
(43) Pub. Date: Oct. 15, 2026

(54) Systems and Methods for Converting a Natural Language Input Prompt to a Structured Query

(71) Applicant: MCKINSEY & COMPANY, INC., New York, NY (US)

(72) Inventors: Suganya Sivakumar, Novi, MI (US); Briana Aleida Worley Sallee, Dallas, TX (US); Jérémi DeBlois-Beaucage, Montreal (CA); Peter John Mondlock, Highland Park, IL (US); Jack Harry Keenan, III, Montclair, NJ (US); Robert Lester Muil, Market Harborough (GB)

(21) Appl. No.: 19/178,630

(22) Filed: Apr. 14, 2025

(51) Int. Cl. G06F 16/2452; G06F 16/28

(52) U.S. Cl. CPC G06F 16/24522; G06F 16/285

(57) ABSTRACT

Systems and methods of converting natural language input prompts into structured queries are disclosed herein. Such systems and methods may receive an input prompt from a user, generate a refined prompt form the input prompt, match the input prompt to a predefined template selected from a plurality of predefined templates based upon a degree of similarity (e.g., a silhouette coefficient) between the input predefined template, and generate a structured query based on the refined prompt and the matched predefined template. Named entity recognition and disambiguation may be performed to generate the refined prompt by identifying specific parameters to be used in generating the structured query from the predefined template.

### FIELD OF THE DISCLOSURE

The present disclosure relates generally to techniques for transforming natural language user prompts into structured queries, and more particularly, to systems and methods that leverage template matching and machine learning algorithms for prompt refinement and query generation.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Accurately formulating a user prompt for a large language model (LLM) has become increasingly important in ensuring reliable responses. The interpretation of a user's prompt by an LLM can vary significantly depending on factors such as phrasing, structure, and contextual cues, leading to inconsistencies in the generated output. This concern is more pronounced when the prompt is used to generate a structured query (e.g., an SQL query), as any ambiguity or inaccuracy in the user prompt may result in an incorrect or incomplete query, ultimately retrieving erroneous information from a database or knowledge repository.

Translating a user prompt into a structured query that accurately captures the intended meaning presents significant challenges. Current automated methods for converting natural language prompts into structured queries often suffer from inaccuracies, generating incorrect or suboptimal queries that may lead the LLM to produce misleading or erroneous responses. These challenges highlight the need for more precise and reliable mechanisms to bridge the gap between natural language input and structured query generation.

### SUMMARY

Disclosed herein are systems, methods, and computer-readable media storing instructions to solve the problems associated with current techniques for generating and using structured queries from natural language prompts to LLMs through an improved technique of query template matching (QTM). In some aspects, the techniques described herein relate to a method for converting natural language input prompts into structured queries, the method including: receiving an input prompt from a user, wherein the input prompt includes a natural language query; generating a refined prompt from the input prompt by applying one or more machine learning algorithms; matching the input prompt to a predefined template selected from a plurality of predefined templates based upon a degree of similarity between the input prompt and the predefined template, wherein each predefined template of the plurality of predefined templates includes a cluster of reference prompts; and generating a structured query based on the refined prompt and the matched predefined template.

The method may further include: executing the structured query to retrieve structured data from a memory system; inputting the input prompt and the retrieved structured data into a large language model; and receiving a response generated by the large language model based on the input prompt and the retrieved structured data.

The method may further include: inputting the input prompt and the structured query into a large language model; and receiving a response to the structured query from the large language model.

The method may further include: generating a user prompt based on at least the input prompt and contextual data; inputting the user prompt into a large language model; and receiving a response to the user prompt from the large language model.

According to some embodiments, matching the input prompt to the predefined template selected from the plurality of predefined templates based upon the degree of similarity between the input prompt and the predefined template may further include matching the refined prompt to the predefined template selected from the plurality of predefined templates based upon the degree of similarity between the refined prompt and the predefined template.

The method may further include: generating a plurality of clusters of reference prompt vectors corresponding to the plurality of predefined templates by embedding each of the plurality of clusters of reference prompts into a vector space; and generating an input prompt vector by embedding the input prompt into the vector space.

According to some embodiments, matching the input prompt to the predefined template selected from the plurality of predefined templates based upon the degree of similarity may further include: applying a cluster quality metric to the input prompt vector and each cluster of reference prompt vectors to identify one or more similar clusters of reference prompts that exceed a cluster quality threshold; applying a machine learning classifier to the one or more similar clusters of reference prompt vectors to rank the one or more similar clusters of reference prompts; and matching the input prompt to the predefined template including a highest-ranked cluster of reference prompts.

According to some embodiments, the cluster quality metric may be a silhouette coefficient used to determine a similarity between each cluster of reference prompt vectors and the input prompt vector.

According to some embodiments, matching the input prompt to the predefined template selected from the plurality of predefined templates based upon the degree of similarity may further include: determining that no cluster of reference prompt vectors meet or exceed a cluster quality threshold; and matching the input prompt to the predefined template indicating an absence of a valid match.

According to some embodiments, generating the refined prompt from the input prompt may further include: identifying one or more relevant entities within the input prompt using a first machine learning algorithm; replacing the one or more relevant entities with one or more placeholders; identifying one or more extracted values for the one or more placeholders by applying a second machine learning algorithm to the one or more placeholders; and replacing the one or more placeholders with the one or more extracted values to determine the refined prompt.

According to some embodiments, the one or more placeholders may specify entity types corresponding to the one or more relevant entities.

In some aspects, the techniques described herein relate to a computer system for converting natural language input prompts into structured queries including: one or more processors, and a non-transitory program memory coupled to the one or more processors and storing executable instructions that, when executed by the one or more processors, causes the computer system to: receive an input prompt from a user, wherein the input prompt includes a natural language query; generate a refined prompt from the input prompt by applying one or more machine learning algorithms; match the input prompt to a predefined template selected from a plurality of predefined templates based upon a degree of similarity between the input prompt and the predefined template, wherein each predefined template of the plurality of predefined templates includes a cluster of reference prompts; and generate a structured query based on the refined prompt and the matched predefined template.

In some aspects, the techniques described herein relate to a non-transitory computer-readable medium storing executable instructions for converting natural language input prompts into structured queries that, when executed by one or more processors, cause the one or more processors to: receive an input prompt from a user, wherein the input prompt includes a natural language query; generate a refined prompt from the input prompt by applying one or more machine learning algorithms; match the input prompt to a predefined template selected from a plurality of predefined templates based upon a degree of similarity between the input prompt and the predefined template, wherein each predefined template of the plurality of predefined templates includes a cluster of reference prompts; and generate a structured query based on the refined prompt and the matched predefined template.

### BRIEF DESCRIPTION OF THE DRAWINGS

FIG. 1 illustrates a block diagram of an example communication system in which a method for converting natural language input prompts into structured queries can be implemented.

FIG. 2 illustrates a block diagram of an example language model server that can operate in the system of FIG. 1.

FIG. 3 illustrates a block diagram of an example prompt conversion server that can operate in the system of FIG. 1.

FIGS. 4A and 4B illustrate a combined block and logic diagram that depicts the generation of a user input using the prompt conversion server.

FIG. 5 is a flow diagram of an example method for converting natural language input prompts into structured queries.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112 (f).

Broadly speaking, the techniques of the present disclosure relate to a system for converting natural language input prompts into structured queries. In operation, the system may receive an input prompt from a user, refine the input prompt into a refined prompt by applying one or more machine learning algorithms. The system may additionally match the input prompt to a predefined template selected from a plurality of predefined templates based upon a degree of similarity between the input prompt and the predefined template. The system may then generate a structured query based on the refined prompt and the matched predefined template.

As large language models (LLMs) generate structured queries (e.g., SQL queries) from natural language input prompts, whether for direct conversion into a structured query or to enhance the LLM's understanding of the input, various challenges arise due to the inherent variability in natural language. Minor differences in phrasing can lead to significantly different interpretations by the LLM, often resulting in erroneous or incomplete structured queries. Moreover, conventional methods that directly translate user prompts into structured queries without proper validation frequently introduce inaccuracies. Accordingly, the present techniques aim to improve accuracy of generating a structured query from natural language input by incorporating predefined templates and machine learning algorithms, ensuring that only verified and syntactically correct structured queries are produced.

Existing query generation techniques often rely on direct natural language-to-structured query conversion, which is prone to inconsistencies and high error rates. These conventional approaches frequently misinterpret user intent due to ambiguities in natural language, leading to incorrect structured queries (e.g., SQL queries) and unreliable outputs. To improve the accuracy of structured query conversion, the present techniques may utilize verified predefined templates. Each predefined template may include a cluster of reference prompts and an associated structured query template. The system may match the input prompt to the predefined template containing the cluster of reference prompts that is most similar (e.g., semantically similar) to the input prompt. Once a match is identified, the system may use the structured query template of the matched predefined template as a framework for converting the natural language input into a structured query. This template-based approach significantly reduces errors associated with direct natural language interpretation by ensuring that the structured query follows a validated format. Additionally, the present techniques ensure that an input prompt is converted into a structured query only when a valid match is found. If no sufficiently similar predefined template exists, the system may notify the user of the absence of a valid match rather than generating an arbitrary structured query, further minimizing the risk of incorrect query formation.

Additionally, the present techniques utilize machine learning algorithms to refine the input prompt before converting the input prompt into a structured query. Conventional approaches often map words from the natural language input directly to variables in the structured query, leading to errors and inconsistencies. For example, in the prompt “What were the total sales in California last year?”, traditional methods may use “total sales” as a variable without identifying the corresponding database entry or column name. This can result in mismatches or incorrect query execution.

By contrast, the present techniques employ machine learning algorithms to identify key terms within the input prompt and map them to appropriate placeholders and variables in the structured query. For instance, in the prompt “What were the total sales in California last year?”, the system may recognize “total sales,” “California,” and “last year” as essential variables for query construction. Using named entity recognition (NER) and named entity disambiguation (NED), the present techniques can translate these terms into the correct database entries. For example, “total sales” may be mapped to “revenue,” and “last year” may be replaced with a specific year, such as “2024.” By leveraging these machine learning algorithms, the present techniques ensure greater accuracy and consistency in structured query generation, minimizing errors caused by direct word-to-variable conversions.

The present techniques enhance the functionality of computing systems by enabling the rapid expansion of structured data retrieval capabilities through query template matching (QTM). Conventional approaches to structured query generation rely on custom tuning of a large language model whenever a new query pattern arises. For instance, when a new type of natural language input needs to be supported, additional prompt variations must be introduced, a corresponding structured query must be created, and specialized code must be developed to train the large language model to recognize and convert the new query pattern. This process often requires creating custom scripts or heuristic-based methods to detect relevant user inputs, which is both time-consuming and prone to errors. Each new query must then be validated, tested, and integrated into the large language model, often requiring modifications to the query execution logic. As more query patterns are introduced, these manual interventions increase system complexity, elevate the risk of errors, and demand frequent updates, making the system difficult to scale efficiently.

By contrast, the present techniques leverage QTM to automate structured query generation. Instead of relying on a large language model to directly convert an input prompt into a structured query, the present techniques use prompt matching to dynamically associate input prompts with predefined query templates stored in a vector space. This eliminates the need for manual training of the large language model to interpret new natural language phrases and convert them into structured queries. New query templates can be added dynamically without modifying the core system logic (e.g., the large language model), allowing new query patterns to be integrated simply by introducing a new predefined query template. For example, if a new natural language pattern such as “Show me all customer transactions” emerges, the present techniques can create a new predefined query template by generating a cluster of reference prompts containing variations of the phrase “show me all” and associating them with a structured query template that maps to “SELECT*FROM transactions;”. This template-driven approach enhances adaptability, improves query accuracy, and significantly accelerates structured query deployment. By reducing the need for manual interventions and large language model retraining, the system becomes more scalable, efficient, and resilient to evolving user needs.

The present techniques thus improve the functionality of computing systems by enhancing the accuracy and reliability of structured queries, which in turn leads to more precise and contextually relevant responses from a large language model (LLM). Conventional approaches that rely on direct natural language input often result in ambiguous or incorrect structured queries, leading to incomplete or inaccurate data retrieval. When the LLM is provided with poorly structured or imprecise data, it may generate misleading, irrelevant, or hallucinated responses. By contrast, the present techniques ensure that structured queries are accurately formulated using predefined templates and machine learning models, minimizing errors in data retrieval. As a result, the LLM may receive well-structured input prompt, improving its ability to generate factually correct and relevant responses. This enhancement may be important in applications that require high precision, such as financial reporting, healthcare analytics, or legal research, where incorrect or incomplete information can have significant consequences. By improving the structured query generation process, the present techniques directly contribute to the reliability and accuracy of LLM-generated outputs, thereby enhancing the overall performance of the computing systems that rely on natural language processing for data-driven decision-making.

### Example Hardware and Software Components

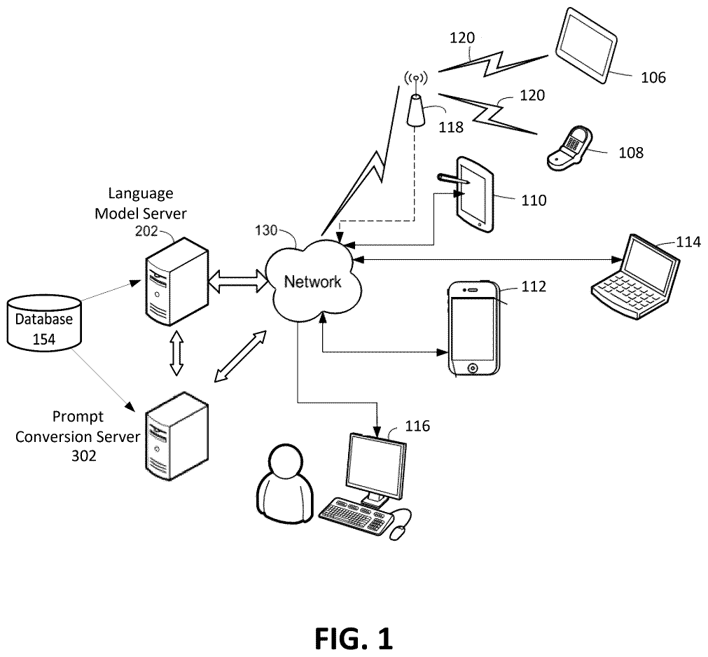

Referring to FIG. 1, an example comprehensive prompt conversion system 100 includes a language model server 202, a prompt conversion server 302, and client devices 106-116 which may be communicatively connected through a network 130, as described below. In some embodiments, the language model server 202 and the prompt conversion server 302 may communicate with the client devices 106-116 via wireless signals 120 over a digital network 130, which can be any suitable local or wide area network(s) including a Wi-Fi network, a Bluetooth network, a cellular network such as 3G, 4G, Long-Term Evolution (LTE), 5G, the Internet, etc. In some instances, the client devices 106-116 may communicate with the digital network 130 via an intervening wireless or wired device 118, which may be a wireless router, a wireless repeater, a base transceiver station of a mobile telephony provider, etc. The language model server 202 and the prompt conversion server 302, may also communicate with each other over the digital network 130, or may directly communicate with each other wired/wirelessly.

The client devices 106-116 may include, by way of example, a tablet computer 106, a network-enabled cell phone 108, a personal digital assistant (PDA) 110, a mobile device smart-phone 112 also referred to herein as a “mobile device,” a laptop computer 114, a desktop computer 116, a portable media player (not shown), a wearable computing device (not shown), a smart watch, a phablet, any device configured for wired or wireless RF (Radio Frequency) communication, etc.

Each of the client devices 106-116 may interact with the language model server 202 to transmit an input prompt and receive a corresponding response. The client devices 106-116 allow users to access the language model hosted on the language model server 202 from various environments and interfaces, such as API calls, chat interfaces, or other application integrations. Upon receiving the input prompt, the language model server 202 may process the input prompt using the language model to generate a response. The language model server 202 may then transmit the response to the client devices 106-116.

Each of the client devices 106-116 may also interact with the prompt conversion server 302 to convert the input prompt into a structured query. The prompt conversion server 302 may match the input prompt with a predefined template selected from a plurality of predefined templates. The prompt conversion server 302 may also generate a refined prompt from the input prompt by applying one or more machine learning algorithms (e.g., named entity recognition and named entity disambiguation). The prompt conversion server 302 may then generate the structured query based on the refined prompt and the matched predefined template. The prompt conversion server 302 may additionally proceed to generate a user prompt based on the structured query and contextual data. The prompt conversion server 302 may then transmit the user prompt to the language model server 202.

In some embodiments, the language model server 202 and the prompt conversion server 302 may communicate directly with each other. A client device 106-116 may transmit an input prompt to the language model server 202, and the language model server 202 may transmit the input prompt directly to the prompt conversion server 302. For example, a user may submit the input prompt via chat interface hosted by the language models server 202. The prompt conversion server 302 may then convert the input prompt into a structured query, and generate a user prompt based on the structure query and context data. The prompt conversion server 302 may then send the user prompt to the language model server 202, and the language model server 202 may then generate a response. The language model server may then transmit the response to the client device 106-116 and/or to the prompt conversion server 302.

In some other embodiments, the prompt conversion server 302 may transmit the structured query to the language model server 202, and the language model server 202 may generate the user prompt based on the structured query and context data. The language model server 202 may then generate a response based on the user prompt using its large language model.

In some embodiments, the client device 106-116 may transmit an input prompt to the prompt conversion server 302. For example, a user may submit the input prompt via chat interface hosted by the prompt conversion server. The prompt conversion server 302 may then convert the input prompt into a structured query, and generate a user prompt based on the structure query and context data. The prompt conversion server 302 may then send the user prompt to the language model server 202, and the language model server 202 may then generate a response. The language model server may then transmit the response prompt conversion server 302, and the prompt conversion server may then transmit the response to the client device 106-116.

The language model server 202 and the prompt conversion server 302 may be communicatively connected to a database 154, which stores various types of user-related information. This information may include data associated with users operating client devices 106-116, and interacting with the language model server 202 and the prompt conversion server 302. The database 154 may store historical input prompts, corresponding structured queries to the historical input prompts, and corresponding responses generated by the system. Additionally, the database 154 may store user profile information, chat history, user interaction patterns, frequently used query structures, preferred response formats, past interactions, preferences, and domain-specific knowledge. These records may be utilized by the language model server 202 and/or the prompt conversion server 302 as context data to enhance prompt generation. By leveraging historical user interactions, including past queries, structured query mappings, and refinements, the language model server 202 and the prompt conversion server 302 can generate more accurate and contextually relevant user prompts.

The database 154 may store a plurality of predefined templates, each associated with a cluster of reference prompts. Each predefined template includes a verified structured query that the prompt conversion server 302 can use as a basis for generating a structured query from an input prompt. Additionally, each predefined template may be associated with a cluster of reference prompts that share similar semantic meanings, allowing the system to match user inputs to the most relevant query template. For example, a predefined template for retrieving customer transaction history may include a structured query such as: “SELECT*FROM transactions WHERE customer_id={customer_id};”. This predefined template may be associated with a cluster of reference prompts such as “Show me all purchases made by customer X,” “List all transactions for user X,” or “Retrieve the order history of customer X.” When a user input is similar to such cluster of reference prompts, the prompt conversion server 302 may generate a structured query based on the corresponding structured query template.

The database 154 may store a knowledge database that serves as a reference for users of client devices 106-116 when generating input prompts and as a data source for executing structured queries by the language model server 202 and/or the prompt conversion server 302. The prompt conversion server 302 may also utilize the knowledge database during named entity disambiguation to identify one or more extracted values for an input prompt, ensuring that the relevant entities are correctly matched with their corresponding variable names.

The database 154 may store training data used by the language model server 202 to train and refine its language model. Additionally, the database 154 may store training datasets for the prompt conversion server 302, which are used to train one or more machine learning models associated with various modules.

The language model of the language model server 202 and the one or more machine learning models of the prompt conversion server 302 that use a machine learning model may be configured to implement machine learning, such that the model/engine “learns” to analyze, organize, and/or process data without being explicitly programmed. Machine learning may be implemented through machine learning methods and algorithms. In one exemplary embodiment, a machine learning module may be configured to implement machine learning methods and algorithms.

In some embodiments, at least one machine learning method and algorithm may be applied, which may include, but is not limited to, the following: linear or logistic regression, instance-based algorithms, regularization algorithms, decision trees, Bayesian networks, naïve Bayes algorithms, cluster analysis, association rule learning, neural networks (e.g., convolutional neural networks, deep learning neural networks, combined learning module or program), deep learning, combined learning, reinforced learning, dimensionality reduction, support vector machines, k-nearest neighbor algorithms, random forest algorithms, gradient boosting algorithms, Bayesian program learning, voice recognition and synthesis algorithms, image or object recognition, optical character recognition, natural language understanding, and/or other ML programs/algorithms either individually or in combination. In various embodiments, the implemented machine learning methods and algorithms are directed toward at least one of several categorizations of machine learning, such as supervised learning, unsupervised learning, and reinforcement learning.

In one embodiment, the language model and the one or more machine learning models may employ supervised learning, which involves identifying patterns in existing data to make predictions about subsequently received data. Specifically, the language model and the one or more machine learning models may be “trained” using training data, which includes example inputs and associated example outputs. Based upon the training data, the language model and the one or more machine learning models may generate a predictive function which maps outputs to inputs and may utilize the predictive function to generate machine learning outputs based upon data inputs.

In another embodiment, the language model and the one or more machine learning models may employ unsupervised learning, which involves finding meaningful relationships in unorganized data. Unlike supervised learning, unsupervised learning does not involve user-initiated training based upon example inputs with associated outputs. Rather, in unsupervised learning, the language model and the one or more machine learning models may organize unlabeled data according to a relationship determined by at least one machine learning method/algorithm employed by the language model and the one or more machine learning models. Unorganized data may include any combination of data inputs and/or machine learning outputs as described above.

In yet another embodiment, the language model and the one or more machine learning models may employ reinforcement learning, which involves optimizing outputs based upon feedback from a reward signal. Specifically, the language model and the one or more machine learning models may receive a user-defined reward signal definition, receive a data input, utilize a decision-making model to generate a machine learning output based upon the data input, receive a reward signal based upon the reward signal definition and the machine learning output, and alter the decision-making model so as to receive a stronger reward signal for subsequently generated machine learning outputs. Other types of machine learning may also be employed, including deep or combined learning techniques.

After training, machine learning programs (or information generated by such machine learning programs) may be used to evaluate additional data. Such data may be and/or may be related to intent data, user device data, and/or other data that was not included in the training dataset. The trained machine learning programs (or programs utilizing models, parameters, or other data produced through the training process) may accordingly be used for determining, assessing, analyzing, predicting, estimating, evaluating, or otherwise processing new data not included in the training dataset.

It is to be understood that supervised machine learning and/or unsupervised machine learning may also comprise retraining, relearning, or otherwise updating models with new, or different, information, which may include information received, ingested, generated, or otherwise used over time.

Moreover, although the methods described elsewhere herein may not directly mention machine learning techniques, such methods may be read to include such machine learning for any determination or processing of data that may be accomplished using such techniques. In some aspects, such machine learning techniques may be implemented automatically upon occurrence of certain events or upon certain conditions being met. In any event, use of machine learning techniques, as described herein, may begin with training a machine learning program, or such techniques may begin with a previously trained machine learning program.

### Language Model Server

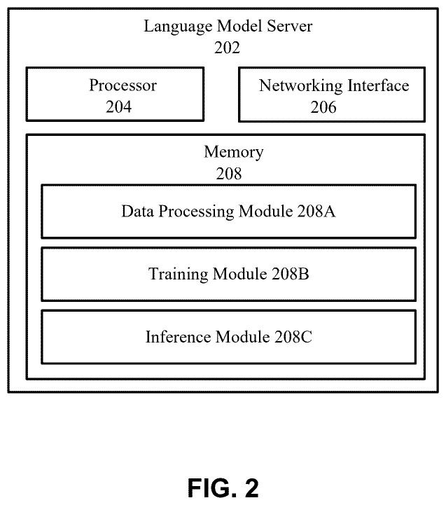

Turning now to FIG. 2, the language model server 202 may include one or more processors 204, a networking interface 206, and one or more memories 208. The memories 208 may comprise a data processing module 208A, a training module 208B, and an inference module 208C. The language model server 202 may be connected to a database 154, which stores training data which the language model server 202 can use to train its language model.

As shown in FIG. 2, the memories 208 may store various applications for execution by the processor 204. The language model server 202 may use the training module 208B to train a language model. The training module 208B may employ various machine learning techniques such as supervised learning, unsupervised learning, and reinforcement learning to train the language model as described in FIG. 1. The training module 208B may use the training data from the database 154 to train the language model.

The language model server 202 may use the data processing module 208A to process data before it is used by the training module 208B to train the model. The data processing module 208A may be configured for tasks such as data cleaning, normalization, tokenization, and feature extraction. These preprocessing steps ensure that the data is in a suitable format for training the language model, enhancing the model's ability to learn effectively from the data. The language model server 202 may additionally use the data processing module 208A to transform input prompts received from client devices 106-116 or a prompt conversion server 302 to a format that is suitable for the language model to process and determine a response.

The inference module 208C may use the language model trained by the training module 208B to generate responses to input prompts received from client devices 106-116 or the prompt conversion server 302. The inference module 208C may first utilize the data processing module 208A to process the input prompts to match the format expected by the trained language model. The inference module 208C may then feed the preprocessed queries into the language model to obtain responses.

The language model server 202 may receive training data from the database 154 via networking interface 206 to train the language model. The language model server 202 may additionally receive inputs (e.g., input prompts) from the client devices 106-116 and/or prompt conversion server 302, and transmit outputs (e.g., responses) to the client devices 106-116 and/or the prompt conversion server 302 via the networking interface 206.

The networking interface 206 may enable the language model server 202 to communicate with other devices, and/or any other suitable devices or combinations thereof. The networking interface 206 may support wired or wireless communications, such as USB, Bluetooth, Wi-Fi Direct, Near Field Communication (NFC), etc. The networking interface 206 may enable the language model server 202 to communicate via a wireless communication network such as a fifth-, fourth-, or third-generation cellular network (5G, 4G, or 3G, respectively), a Wi-Fi network (802.11 standards), a WiMAX network, or any other suitable wide area network (WAN), local area network (LAN), or personal area network (PAN), etc. Moreover, the network may be a single communication network, or may include multiple communication networks of one or more types (e.g., one or more wired and/or PANs or LANs, and/or one or more WANs such as the Internet).

The one or more processors 204 may include any suitable number of processors and/or processor types. For example, the processors 204 may include one or more CPUs and one or more graphics processing units (GPUs). Generally, each of the processors 204 may be configured to execute software instructions stored in the corresponding one or more memories 208. The memories 208 may include one or more persistent memories (e.g., a hard drive and/or solid-state memory) and may store one or more applications, modules, and/or models, such as the data processing module 208A, the training module 208B, and/or the inference module 208C.

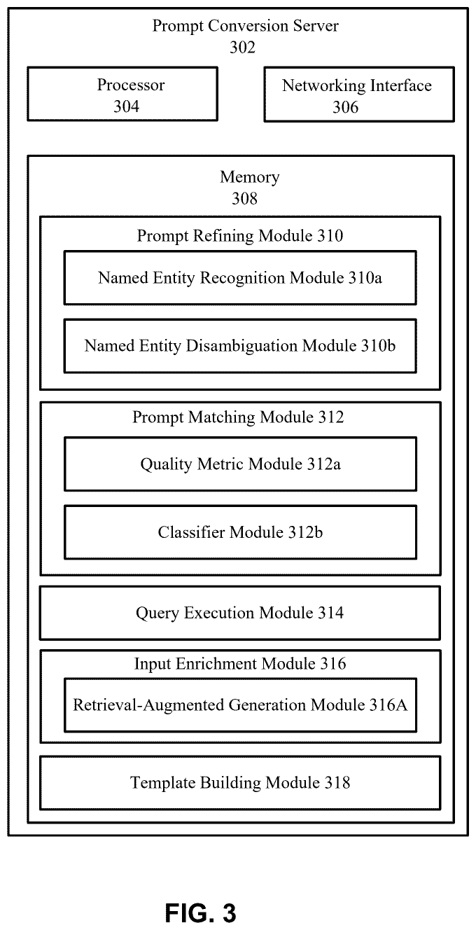

Referring now to FIG. 3, the prompt conversion server 302 can include one or more processors 304, a networking interface 306, and one or more memories 308. The memories 308 include a prompt refining module 310, prompt matching module 312, query execution module 314, input enrichment module 316, and template building module 318. The prompt refining module 310 may comprise named entity recognition (NER) module 310a and named entity disambiguation (NED) module 310b. The prompt matching module 312 may comprise quality metric module 312a and a classifier module 312b. The input enrichment module 315 may comprise retrieval-augmented generation (RAG) module 316A.

The prompt conversion server 302 may receive an input prompt from a user via a user device (e.g., client devices 106-116). The user may transmit the input prompt through a chat interface connected to the language model server 202, which then forwards the prompt to the prompt conversion server 302 for further processing. In some embodiments, the prompt conversion server 302 may receive the input prompt directly from the user device without routing it through the language model server 202. The input prompt may be a natural language prompt that the user submits to obtain a relevant response. For example, a user may input, “Show me the total sales for Acme Corp last year.” This input prompt may contain natural language terms that need to be structured into a query format that can be processed by a database system.

Upon receiving the input prompt, the prompt conversion server 302 may utilize the prompt refining module 310 to generate a refined prompt. The refined prompt may be a modified version of the input prompt in which relevant entities within the natural language text are replaced with corresponding extracted values that align with the actual database schema or entity names. Additionally, the refinement process may involve translating natural language expressions into a structured format that can be directly applied within a structured query. For example, if the input prompt states, “Show me the revenue for Acme Corp last year,” the refined prompt may be transformed into “Retrieve revenue for Company ID 1243 for the year 2024,” ensuring that entity names are mapped to database-recognized identifiers and date expressions are converted into precise timeframes. In another example, if a user asks, “List all transactions over a thousand dollars,” the refined prompt may convert this into “Retrieve transactions where amount >1000,” standardizing the condition for structured query execution. This transformation ensures that the structured query references the correct database fields and entity identifiers, while also converting natural language inputs into formats that can be directly processed. The prompt conversion server 302 perform refinement process by using one or more machine learning algorithms, including an NER algorithm implemented in the NER module 310a and an NED algorithm implemented in the NED module 310b.

The prompt refining module 310 may first utilize the NER module 310a to identify one or more relevant entities within the input prompt and replace the identified entities with corresponding placeholders. The NER module 310a may apply the NER algorithm, which may be a machine learning model trained on large datasets containing labeled natural language text with annotated named entities. This training may enable the NER model to learn patterns and contextual cues that distinguish specific entity types within natural language input. To achieve accurate relevant entity detection and classification, the NER algorithm may employ advanced natural language processing techniques, such as transformers (e.g., BERT, ROBERTa) or probabilistic graphical models like conditional random fields (CRFs). Transformers may leverage self-attention mechanisms to capture dependencies between words across long-range contexts, allowing the model to recognize named entities even when they appear in different syntactic structures. CRFs, on the other hand, may provide a structured prediction approach that considers the sequential nature of text, ensuring that entity classification remains consistent across sentences.

The NER module 310a may then replace each detected entity with a placeholder representing the entity type such as company names, dates, monetary values, and other structured data references. For example, if the input prompt states, “Show me the revenue for Acme Corp last year,” the NER module 310a may apply the NER algorithm to analyze the text and identify “revenue” as an entity of type financial metric, “Acme Corp” as an entity of type company, and “last year” as an entity of type date. The NER module 310a may then replace these identified entities with corresponding placeholders, transforming the output into “Show me the [FINANCIAL_METRIC] for [COMPANY_NAME] [DATE_PERIOD].” In another example, if a user inputs, “List all transactions over a thousand dollars,” the NER module 310a may apply the NER algorithm to detect “transactions” as an entity of type financial metric and “a thousand dollars” as an entity of type monetary value. The NER module 310a may then replace these entities with placeholders, producing the refined output “List all [FINANCIAL_METRIC] over [MONETARY_VALUE].”

The prompt refining module 310 may then utilize the NED module 310b to replace the identified placeholders with corresponding extracted values. The NED module 310b may apply the NED algorithm (or model), which maps placeholders to precise database-compatible values of the knowledge base stored in the database 154, ensuring that the structured query accurately represents the intended data retrieval. While the NER module 310a identifies and classifies entities, the NED module 310b ensures that each recognized entity is correctly linked to a value that corresponds to the underlying structured data. The NED module 310b may comprise a machine learning model trained on labeled datasets that map recognized entities and/or placeholders to their respective database entries. By leveraging historical query patterns, contextual embeddings, and relational data, the NED module 310b may resolve the placeholders based on learned associations.

The NED algorithm may employ multiple techniques to determine the correct extracted values for placeholders and relevant entities, including machine learning-based classification, knowledge graph embeddings, contextual similarity analysis, and/or entity linking based on historical query patterns. A machine learning-based classifier may analyze features such as entity co-occurrence, surrounding context, and semantic embeddings to predict the most likely extracted value for a placeholder. Knowledge graph embeddings may represent entities in a structured space, where related entities are positioned closer together based on their relationships within a knowledge base, helping to distinguish between similar entity names. Contextual similarity analysis may evaluate the surrounding words and sentence structure to ensure that the extracted value aligns with the intended meaning of the input prompt. Additionally, entity linking techniques may utilize lookup tables, reference databases, or previous user queries to resolve placeholders to their most accurate database entry.

For example, if the refined prompt produced by the NER module 310a is “Show me the [FINANCIAL_METRIC] for [COMPANY_NAME] [DATE_PERIOD],” the NED module 310b may apply the NED algorithm to resolve the placeholders to concrete values. If “[COMPANY_NAME]” corresponds to entity value “Acme Corp,” but multiple records in the database contain variations such as “Acme Corporation, Inc.” and “Acme Corp USA,” the NED algorithm may analyze historical query patterns (including previous queries within a user session), company relationships, and database references to determine the correct match, such as “Company ID 1243.” Similarly, “[DATE_PERIOD]” may be mapped to entity value “last year,” which the NED algorithm converts into a database-compatible range, such as “2023 Jan. 1 to 2023 Dec. 31.” “[FINANCIAL_METRIC]” may correspond to entity value “revenue,” which may map to the database field “revenue,” ensuring that the structured query references the appropriate column. Therefore, the final resolved prompt may be “Show me the revenue for Company ID 1243 for the period 2023 Jan. 1 to 2023 Dec. 31.”

In another example, if the refined prompt produced by the NER module 310a is “List all [FINANCIAL_METRIC] over [MONETARY_VALUE],” the NED module 310b may apply the NED algorithm to resolve “[FINANCIAL_METRIC]” and “[MONETARY_VALUE]” to concrete values. If “[FINANCIAL_METRIC]” corresponds to an entity value “transactions,” which may map to database field “transactions,” and “[MONETARY_VALUE]” corresponds to an entity value “a thousand dollars,” the NED algorithm may interpret

“[MONETARY_VALUE]” by recognizing currency expressions and numerical phrases as part of its entity resolution process. The NED algorithm may then convert “a thousand dollars” into “1000” to ensure compatibility with structured queries. Therefore, the final resolved prompt may be “List all transactions over 1000.”

In some embodiments, the NED module 310b may be unable to identify a relevant entity or a corresponding placeholder. For instance, if the knowledge database only contains information on registered companies and their financial records, but the placeholder pertains to an unrecognized entity, such as a company that does not exist in the database, the NED module 310b may fail to resolve the entity. In such a case, the prompt refining module 310 may return an indication that there is no matching placeholder value, and the prompt conversion server 302 may notify the language model server 202 that the input prompt is invalid because the entity referenced in the user query does not exist in the knowledge database.

The prompt conversion server 302 may utilize the prompt matching module 312 to match the input prompt to a predefined template. The predefined template may include a structured query template and a cluster of reference prompts associated with the structured query template. The cluster of reference prompts represents variations of natural language expressions that correspond to the same structured query format. For example, a predefined template may contain a structured query designed to retrieve financial data such as “SELECT revenue FROM financial_reports WHERE report_period={DATE_PERIOD}”, and its associated cluster of reference prompts may include phrases such as “Show me the revenue for last quarter,” “What was the total income in Q4?”, and “Retrieve earnings for the previous quarter.” The prompt matching module 312 may determine the most appropriate predefined template by comparing the input prompt against a cluster of reference prompts associated with each predefined template. The module evaluates a degree of similarity between the input prompt and the cluster of reference prompts in each predefined template, selecting the predefined template comprising a cluster of reference prompts that best matches the input prompt.

The prompt matching module 312 may determine the similarity between the input prompt and each predefined template from a plurality of predefined templates. To achieve this, the prompt matching module 312 may embed a plurality of clusters of reference prompts corresponding to the plurality of the predefined templates into a vector space to generate a plurality of clusters of reference prompt vectors. Each reference prompt within a cluster may be converted into a reference prompt vector, such that the cluster of reference prompts forms a group of vectors in the vector space. The vector space may be a high-dimensional representation where semantically similar prompts are positioned closer together.

The prompt matching module 312 may also generate an input prompt vector by embedding the input prompt into the same vector space. For instance, each reference prompt within a cluster of reference prompts may be transformed into a reference prompt vector that captures its semantic meaning, while the input prompt is similarly converted into an input prompt vector. By embedding the plurality of clusters of reference prompt vectors and the input prompt vector into the same vector space, the prompt matching module 312 may enable a similarity-based comparison between the input prompt and each cluster of reference prompts.

The prompt matching module 312 may utilize a language model to convert the plurality of clusters of reference prompts and/or the input prompt into reference prompt vectors and/or the input prompt vector. The language model may embed each of the plurality of clusters of reference prompts into a vector space to generate the plurality of clusters of reference prompt vectors and embed the input prompt into the vector space to generate the input prompt vector. The language model may generate these vector representations by capturing the semantic relationships between words and phrases. In some embodiments, the predefined template may already store the plurality of clusters of reference prompt vectors.

The prompt matching module 312 may then utilize the quality metric module 312a to determine the similarity between the input prompt vector and each cluster of reference prompt vectors. The quality metric module 312a may apply a cluster quality metric to assess the degree of similarity between the input prompt vector and each cluster of reference prompt vectors. One such cluster quality metric may be a silhouette coefficient, which evaluates how well the input prompt vector fits within a given cluster. The quality metric module 312a may determine whether assigning the input prompt vector to a particular cluster improves or lowers the overall quality of clustering.

The silhouette coefficient may be used to determine whether adding an input prompt vector to a cluster of reference prompt vectors improves or lowers the quality of clustering. It may be a metric that evaluates how well a data point (in this case, the input prompt vector) fits within its assigned cluster relative to other clusters. The silhouette coefficient S(i) for a data point i may be computed as

$$S ( i ) = \frac{b ( i ) - a ( i )}{max ( a ( i ) , b ( i ) )}$$

where a(i) may be average intra-cluster distance, i.e., the average distance between the input prompt vector and all other vectors within the same cluster (cohesion) and b(i) may be the average inter-cluster distance, i.e., the average distance between the input prompt vector and the closest neighboring cluster (separation).

For instance, if assigning the input prompt vector to a cluster of reference prompt vectors enhances the cohesion of the cluster-meaning that the prompt fits well within the existing structure of semantically similar reference prompts-then the cluster is considered a possible match, and the input prompt vector and the cluster of reference prompt vectors are determined to be similar. Conversely, if assigning the input prompt vector to a given cluster reduces the overall quality of clustering-indicating that the input prompt does not align well with the reference prompts in the cluster-then the cluster may not be considered a match. The quality metric module 312a may identify one or more similar clusters of reference prompt vectors that exceed a cluster quality threshold, ensuring that only similar clusters of reference prompts to the input prompt is selected. For instance, the cluster quality threshold may be based on whether the silhouette score increases (e.g., silhouette score comes out to be a positive value) after assigning the input prompt vector to a cluster of reference prompt vectors. If adding the input prompt vector improves the silhouette score, the input prompt vector is determined to enhance the cohesion of the cluster, and therefore the cluster of reference prompt vectors is considered a similar cluster of reference prompt vectors. Conversely, if adding the input prompt vector reduces the silhouette score (e.g., silhouette score comes out to be zero or negative value), the input prompt is determined to reduce the cohesion of the cluster, and therefore the cluster of reference prompt vectors is not considered a similar cluster of reference prompt vectors.

The cluster quality metric may include additional methods for determining the similarity between the input prompt vector and a cluster of reference prompt vectors, helping to identify clusters of reference prompts that exceed a predefined cluster quality threshold. Instead of or in addition to the silhouette coefficient, alternative cluster quality metrics may include the median distance or maximum distance from the centroid as thresholding criteria. For instance, if the input prompt vector falls within a specified median distance from the centroid of a cluster of reference prompt vectors, it may be considered similar. Similarly, a maximum distance threshold may be applied, where the input prompt vector must be within a certain distance from the cluster centroid to ensure that it remains semantically relevant or similar to the reference prompts in that cluster. For example, if a cluster of reference prompt vectors is related to financial metrics (e.g., “Show me the revenue for last quarter”), and the input prompt vector “Retrieve Q4 income” is within the median distance threshold, the quality metric module 312a may determine the input prompt vector to be similar to the cluster. Conversely, if the input prompt vector “Show me product sales trends over time” is too far from the cluster centroid based on the maximum distance threshold, the quality metric module 312a may determine the input prompt vector to be not similar to the cluster.

Other possible cluster quality metrics may further refine similarity assessment and improve the accuracy of predefined template selection. For instance, cosine similarity may be used to measure how directionally aligned the input prompt vector is with reference prompt vectors, ensuring that matches are not only close in distance but also semantically similar. Additionally, density-based metrics may be applied to determine whether an input prompt vector falls within a high-density region of reference prompt vectors, further validating its inclusion within a particular cluster.

Upon identifying the one or more similar clusters of reference prompt vectors (and associated one or more similar clusters of reference prompts), the prompt matching module 312 may apply the classifier module 312b to rank these clusters based on their similarity to the input prompt vector and select the cluster with the highest similarity. The classifier module 312b may use a machine learning classifier, such as a supervised learning model, designed to rank the identified clusters according to their relevance to the input prompt vector.

The machine learning classifier may be trained on a dataset comprising historical input prompts, reference prompt clusters, and/or their corresponding structured query mappings. In some embodiments, the machine learning classifier may be trained on a dataset comprising historical input prompt vectors, clusters of reference prompt vectors, and/or their corresponding structured query mapping. Training data may include labeled examples where each input prompt is assigned a similarity score or ranking relative to multiple reference prompt clusters based on semantic similarity. The classifier may learn from features such as silhouette coefficient, vector distances, cosine similarity, word embeddings, and prior user selections, allowing it to rank clusters more effectively.

For instance, if the input prompt is “What were Acme Corp's total earnings last year?”, the classifier may rank clusters containing reference prompts such as “Show me the revenue for Acme Corp in 2023” higher than clusters containing unrelated financial queries like “Retrieve profit margins for Q4.” Based on the classifier's ranking, the prompt matching module 312 may select the most similar cluster.

In some embodiments, the quality metric module 312a may compute a similarity score for each of the one or more clusters of similar reference prompt vectors relative to the input prompt vector. This similarity score may be determined using a cluster quality metric, such as the silhouette score, median distance to the centroid, cosine similarity, or other vector-based similarity measures. The classifier module 312b may then use the one or more similarity scores to rank the clusters of similar reference prompt vectors and identify the most similar cluster of reference prompt vector.

The prompt matching module 312 may then match the input prompt to a predefined template that contains the cluster of reference prompts (vectors) that has the highest similarity to the input prompt (vector). By selecting the highest-ranked cluster, the prompt matching module 312 determines the most relevant structured query template within the predefined template. The prompt conversion server 302, when converting the input prompt into the structured query, may use the structured query template of the matched predefined template as a framework for generating the structured query, ensuring that the conversion process accurately reflects the intended query format.

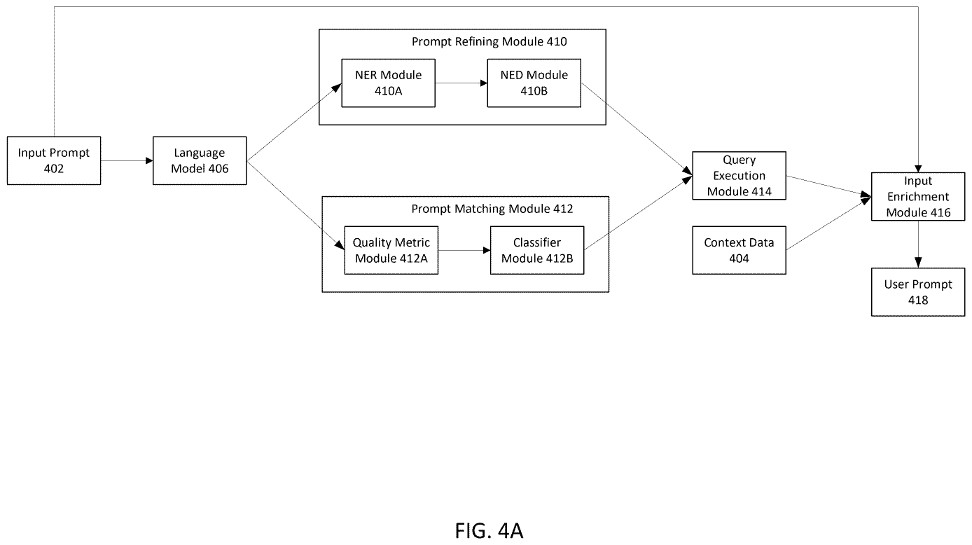

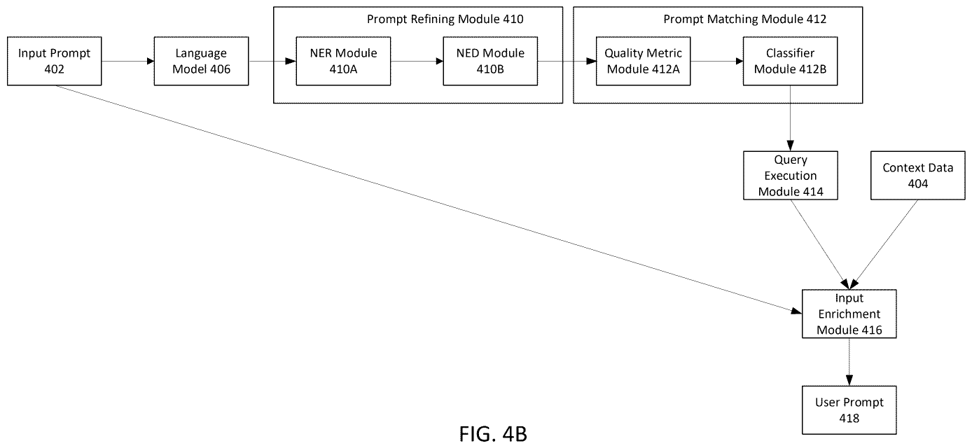

The prompt conversion server 302 may generate the refined prompt from the input prompt using the prompt refining module 310 while simultaneously matching the input prompt to a predefined template selected from the plurality of predefined templates. These processes may occur in parallel, as illustrated in FIG. 4A. In some embodiments, instead of using the original natural language input prompt, the prompt matching module 312 may utilize the refined prompt to identify the most similar predefined template from the plurality of predefined templates. The refined prompt may be the input prompt with relevant entities replaced by structured placeholders (from NER module 310a) or the input prompt with the structured placeholders replaced by the one or more extracted values (from NED module 310b). This process may be further illustrated in FIG. 4B.

In some embodiments, the prompt conversion server 302 may determine that no cluster of reference prompt vectors and the input prompt vector meet or exceed the cluster quality threshold. For instance, if the cluster quality metric is a silhouette coefficient, the prompt conversion server 302 may determine that the silhouette score of each cluster was reduced by the addition of the input prompt vector. The prompt conversion server may then match the input prompt to a predefined template indicating an absence of a valid match. In some embodiments, the prompt matching module 312 may return an indication that there is no cluster of similar reference prompt vectors, and the prompt conversion server 302 may notify the language model server 202 that there is an absence of a valid matching structured query template.

The query execution module 314 may then generate the structured query based on the predefined template, which includes the structured query template, and the refined prompt. The query execution module 314 may construct the structured query by using the structured query template as a framework and replacing query variables (e.g., [FINANCIAL_METRIC], [COMPANY_NAME], [DATE_PERIOD]) with the corresponding extracted values identified from the refined prompt. The query execution module 314 may comprise a machine learning model trained on a dataset consisting of historical structured query templates, corresponding input prompts (or refined prompts), and their corresponding structured queries that align with the templates and input prompts. The model may learn patterns in query construction by analyzing prior mappings between natural language inputs and their corresponding structured query formats. In some embodiments, the query execution module 314 may simply be a rule-based query generation system that directly applies the structured query template by replacing the query variables with the extracted values identified in the refined prompt.

The query execution module 314 may also validate that the generated structured query is syntactically correct, ensuring that it adheres to the rules of the target query language (e.g., SQL, SPARQL, GraphQL) before execution. This validation may include checking for missing or incorrectly formatted query variables, verifying that the query structure conforms to database schema constraints, and applying error correction techniques to resolve minor inconsistencies.

The query execution module 314 may then execute the structured query on the knowledge database from which the structured query and/or the input prompt was generated to retrieve structured data. For instance, if the structured query is “SELECT revenue FROM financial_reports WHERE company_id=1243 AND report_date BETWEEN ‘2023 Jan. 1’ AND ‘2023 Dec. 31’;”, then the structured data returned may be “{“company_id”: 1243, “company_name”: “Acme Corp”, “revenue”: 50000000, “currency”: “USD”, “year”: 2023}.” The query execution module 314 may process the structured query using a standard database query engine such as PostgreSQL or MySQL for relational data, a graph-based system like JanusGraph for Gremlin queries, or other query execution frameworks designed for specific data retrieval needs. The structured query may be written in various query languages, including SQL for relational databases, SPARQL for RDF-based knowledge graphs, Gremlin for graph traversal queries, and Prolog for logic-based reasoning systems. The retrieved structured data may be returned in different formats depending on the database and use case, such as JSON for API responses, RDF for semantic web data, XML for hierarchical data exchange, CSV for tabular data exports, or Parquet for optimized large-scale data processing.

The prompt conversion server 302, upon determining the structured query, may use the input enrichment module 316 to generate a user prompt based on the input prompt, structured query, structured data, and/or context data. The context data may include the user's chat history, profile information, past interactions, preferences, and/or domain-specific knowledge that can help refine the response. This additional context ensures that the large language model generates a response that is more relevant, personalized, and aligned with the user's intent. For instance, the user's chat history may provide insights into previous queries, allowing the prompt conversion server 302 to maintain continuity in conversation. Profile information, such as the user's industry or expertise level, can help tailor responses accordingly. If the structured data retrieved from the knowledge base contains financial reports, the input enrichment module 316 may include explanatory notes or comparisons with historical data to enhance understanding. Once the user prompt is generated, the prompt conversion server 302 may transmit user prompt to the language model server 202, which hosts the large language model. The large language model may process the user prompt and generates a contextually enriched response.

The input enrichment module 316 may use the RAG module 316A when generating the user prompt to enhance the response with relevant external knowledge. Retrieval-augmented generation is a technique that improves the accuracy and relevance of LLM responses by retrieving relevant data from external sources (e.g., the context data) before generating a response. The RAG module 316A may utilize the context data to supplement the structured data retrieved from the knowledge database. For instance, if the structured query retrieves financial data for a company, the RAG module 316A may fetch historical revenue trends, industry benchmarks, or related economic factors to provide deeper context. The RAG module 316A may also retrieve explanatory text, definitions, or reference materials that clarify complex terms used in the structured data. Once the relevant information is retrieved, the input enrichment module 316 may integrate it into the user prompt, ensuring that the large language model has sufficient context to generate an informed and contextually relevant response.

The prompt conversion server 302, upon generating the user prompt, may transmit the user prompt to the language model server 202. The language model server 202, upon receiving the user prompt, may generate a natural-language response based on the user prompt and transmit the response to the prompt conversion server 302 and/or the user device 106-116.

In some embodiments, the prompt conversion server 302 may transmit the input prompt and the structured query to the language model server 202, which hosts the large language model. The large language model in the language model server 202 may be connected to the knowledge database and may execute the structured query to retrieve the structured data. The large language model may then refine the structured data into the natural-language response based on the input prompt and transmit the response to the prompt conversion server 302 and/or user device 106-116.

In another embodiment, the prompt conversion server 302 may transmit the input prompt along with the retrieved structured data to the language model server 202, which hosts the large language model. The large language model may then process the input prompt in conjunction with the structured data to generate a refined natural-language response, and transmit the natural-language response to the prompt conversion server 302 and/or the user device 106-116.

In some other embodiments, the language model server 202 may comprise the input enrichment module 316. For instance, the language model server 202 may receive the input prompt and the structured query from the prompt conversion server 302. The language model server 202 may use the context data to generate a user prompt that integrates the input prompt, the structured query, and relevant context data. The language model server may then process this user prompt to generate a natural-language response and transmit the response to the user device 106-116. In another instance, the language model server 202 may receive the input prompt along with the structured data from the prompt conversion server 302. The language model server may use context data to generate a user prompt that includes the input prompt, the structured data, and any additional context data. The language model server may then generate a natural-language response based on this enriched prompt and transmit the response to the prompt conversion server 302 and/or the user device 106-116.

The prompt conversion server 302 may utilize the template building module 318 to generate a plurality of predefined templates that the prompt matching module 312 may uses to identify a predefined template that matches with the input prompt. The template building module 318 may generate each predefined template of the plurality of predefined templates. Each predefined template may comprise a structured query template and a cluster of reference prompts associated with the structured query template.

When constructing a predefined template, the template building module 318 may verify its accuracy and reliability, ensuring that both the structured query template and the associated cluster of reference prompts are correctly defined and aligned. This verification process may consist of several steps. First, the structured query template syntax may be validated against a reference executor, which ensures that the structured query template is correctly formatted and can be executed without errors. For example, in SQL-based systems, the reference executor checks whether the query follows proper syntax rules, such as ensuring that “SELECT*FROM sales WHERE transaction_date BETWEEN {start_date} AND {end_date};” correctly references existing tables and columns. If an invalid keyword or table name is used, the reference executor flags the issue before deployment.

Next, the template building module 318 may ensure that all entity types and predicates align with the ontology, meaning that the structured query template correctly maps to the relationships and attributes defined in the database or knowledge graph. For instance, if the structured query template is designed to retrieve customer orders, it should reference valid entities such as “customers” and “orders” and use appropriate relationships, such as “customer_id” linking both tables. If the query mistakenly references “user_id” instead of “customer_id”, or tries to filter by an undefined field like “customer_status”, the verification process detects these mismatches. In some embodiments, the structured query template may comprise placeholders identifying the entity types instead of actual entities or extracted values.

The template building module 318 may then test the structured query template against a cluster of reference prompts to confirm that it consistently generates accurate results. This step ensures that different variations of natural language inputs, such as “List all purchases by John Doe” and “Show me the order history for John Doe,” all map to the same structured query and return the expected database records. The template building module 318 may generate the cluster of reference prompts by using a large language model. In some embodiments, upon the confirmation, the template building module 318 may convert the each reference prompt in the cluster of reference prompts into a reference vector by using a language model used in the prompt matching module 312.

The template building module 318 may use a machine learning model to analyze historical input prompts and their corresponding structured queries, identifying frequently used structured queries to designate as structured query templates. For example, structured queries that appear regularly in historical data may be selected as structured query templates. Once the structured queries are determined, the template building module 318 may utilize a large language model to generate a cluster of reference prompts for each structured query template. To enhance the accuracy of reference prompt generation, the template building module 318 may provide the large language model with historical input prompts corresponding to the structured query templates. These reference prompts may capture variations of natural language expressions, ensuring that different input prompts can be effectively mapped to the same structured query. To maintain accuracy and consistency, the structured query templates and their associated clusters of reference prompts undergo a verification process, as described in earlier paragraphs, before being finalized as predefined templates.

The networking interface 306 may enable the prompt conversion server 302 to communicate with other devices, and/or any other suitable devices or combinations thereof. The networking interface 306 may support wired or wireless communications, such as USB, Bluetooth, Wi-Fi Direct, Near Field Communication (NFC), etc. The networking interface 306 may enable the prompt conversion server 302 to communicate via a wireless communication network such as a fifth-, fourth-, or third-generation cellular network (5G, 4G, or 3G, respectively), a Wi-Fi network (802.11 standards), a WiMAX network, or any other suitable wide area network (WAN), local area network (LAN), or personal area network (PAN), etc. Moreover, the network may be a single communication network, or may include multiple communication networks of one or more types (e.g., one or more wired and/or PANs or LANs, and/or one or more WANs such as the Internet).

More generally, the one or more processors 304 may include any suitable number of processors and/or processor types. For example, the processors 304 may include one or more CPUs and one or more graphics processing units (GPUs). Generally, each of the processors 304 may be configured to execute software instructions stored in the corresponding one or more memories 308. The memories 308 may include one or more persistent memories (e.g., a hard drive and/or solid-state memory) and may store one or more applications, modules, and/or models, such as the prompt refining module 310, the prompt matching module 312, the query execution module 314, etc.

FIGS. 4A and 4B illustrates a block and logic diagram of the prompt conversion server 302 generating a user prompt 418. FIG. 4A represents an exemplary logic diagram of the prompt conversion server 302 implementing in parallel both a prompt refining module 410 and a prompt matching module 412 when generating the user prompt 418. FIG. 4B represents an exemplary logic diagram of the prompt conversion server 302 sequentially implementing the prompt matching module 412 using a refined query generated by the prompt refining module 410 when generating the user prompt 418.

In both FIGS. 4A and 4B, a user using a user device (e.g., client devices 106-116) may use a language model 406 to transmit an input prompt (e.g., via a chat interface). The input prompt may include a natural language query. For instance, the input prompt may be “What was Acme Corp's total revenue last year?” or “Retrieve the earnings report for Acme Corp in 2023.” The language model 406, upon receiving the input prompt and recognizing that the input prompt is the natural language query, may transmit the input prompt to the prompt conversion server 302.

In FIG. 4A, upon receiving the input prompt from the user, the prompt conversion server 302 may generate a refined prompt using a prompt refining module 410 and match the input prompt to a predefined template using a prompt matching module 412. The prompt conversion server 302 may execute both the prompt refining module 410 and the prompt matching module 412 in parallel.

The prompt refining module 410 may apply one or more machine learning algorithms, including the natural entity recognition algorithm of a NER module 410A and the natural entity disambiguation algorithm of a NED module 410B, to generate the refined prompt from the input prompt. The prompt refining module 410 may first identify one or more relevant entities within the input prompt using the NER module 410A. For instance, if the input prompt is “What was Acme Corp's total revenue last year?”, the NER module 410A may identify “Acme Corp” as an entity of type company name, “total revenue” as an entity of type financial metric, and “last year” as an entity of type date. The NER module 410A may then replace the one or more relevant entities with one or more placeholders, transforming the prompt into “What was [COMPANY_NAME]'s [FINANCIAL_METRIC] for [DATE_PERIOD]?” The one or more placeholders may specify entity types corresponding to the one or more relevant entities.

The prompt refining module 410 may then use the NED module 410B to identify one or more extracted values for the one or more placeholders. The NED module 410B may utilize the knowledge database to determine the one or more extracted values. For example, the NED module 410B may resolve [COMPANY_NAME] to “Acme”, as “Acme Corp” is represented as “Acme” in the knowledge database. Similarly, it may resolve [FINANCIAL_METRIC] to “revenue”, since “total revenue” is stored as “revenue” in the database schema. Finally, [DATE_PERIOD] may be converted to “2023 Jan. 1 to 2023 Dec. 31”, ensuring that the date range is formatted correctly for structured query execution. The NED module 410B may then replace the one or more placeholders with the one or more extracted values. For example, NED module 410B may produce the refined prompt “What was the revenue for Company ID 1243 for the period 2023 Jan. 1 to 2023 Dec. 31?”

In FIG. 4A, while the prompt refining module 410 is generating the refined prompt, the prompt matching module 412 may match the input prompt to a predefined template selected from a plurality of predefined templates based upon a degree of similarity between the input prompt and the predefined template. Each predefined template of the plurality of predefined templates may comprise a cluster of reference prompts and a structured query template. For example, in a predefined template comprising the structured query template “SELECT revenue FROM financial_reports WHERE company_name={COMPANY_NAME} AND report_date BETWEEN {START_DATE} AND {END_DATE};”, the cluster of reference prompts may include “What was Acme Corp's total revenue last year?”, “Show me the revenue for Acme for 2023.”, “Retrieve Acme's earnings from last year.”, and “How much did Acme make in 2023?”

The prompt matching module 412 may generate an input prompt vector by embedding the input prompt into the vector space. In some embodiments, the prompt matching module 412 may generate a plurality of clusters of reference prompt vectors corresponding to the plurality of predefined templates by embedding each of the plurality of clusters of reference prompts into a vector space. The prompt matching module 412 may utilize a language model to vectorize the input prompt and/or each of the plurality of clusters of reference prompts.

The prompt refining module 412 may utilize a quality metric module 412A to apply a cluster quality metric to the input prompt vector and each cluster of reference prompt vectors to identify one or more similar clusters of reference prompt vectors that exceed a predefined cluster quality threshold. For instance, the cluster quality metric may be silhouette scoring, where the cluster quality threshold is determined based on whether the addition of the input prompt vector increases the silhouette score. If the input prompt vector improves the cohesion within the cluster of reference prompt vectors, meaning that the prompt better fits the existing reference prompts, and increases the silhouette score then the cluster of reference prompt vectors may be considered similar to the input prompt vector.

Once the one or more similar clusters of reference prompt vectors have been identified, the prompt matching module 412 may apply a classifier module 412B to rank the one or more similar clusters of referent prompt vectors using a machine learning classifier. The classifier may be trained to determine which cluster is most relevant based on features such as vector distances, semantic similarity, and historical matching accuracy. In some embodiments, each of the one or more similar clusters of reference prompt vectors may include a similarity score, and the classifier module 412B may directly use this similarity score to rank the clusters. For instance, a higher silhouette score indicates greater cohesion, meaning that the cluster is more internally consistent, and therefore more likely to be the best match for the input prompt. The prompt matching module 412 may then match the input prompt (vector) to the predefined template comprising a highest-ranked cluster of reference prompt (vectors).

In FIG. 4B, upon the prompt refining module 410 generating the refined prompt, the prompt matching module 412 may match the refined prompt to a predefined template selected from a plurality of predefined templates based upon the degree of similarity between the refined prompt and the predefined template. The refined prompt may be the input prompt with one or more relevant entities replaced with one or more placeholders (after applying NER module 410A) or may be the input prompt with one or more placeholders replaced with the one or more extracted values (after applying both NER module 410A and NED module 410B). Similar to FIG. 4A, the prompt matching module 412 may convert the refined prompt into a refined prompt vector, and may utilize the quality metric module 412A and the classifier module 412B to match the refined prompt to the predefined template comprising a highest-ranked cluster of reference prompts. Since the prompt matching module 412 may use the refined prompt of the prompt refining module 410 for matching to the predefined template, the prompt matching module 412 may execute after the prompt refining module 410.

In FIGS. 4A and 4B, upon generating the refined prompt and matching the input prompt to a predefined template, the prompt conversion server 302 may apply a query execution module 414 to generate a structured query based on the refined prompt and the matched predefined template. The query execution module 414 may use the structured query template of the predefined template as a framework and replace the query variables with the corresponding extracted values from the refined prompt. For example, if the refined prompt is “What was the revenue for Acme Corp in 2023?” and the structured query template of the predefined template is “SELECT {FINANCIAL_METRIC} FROM financial_reports WHERE company_name={COMPANY_NAME} AND report_date BETWEEN {START_DATE} AND {END_DATE};”, then the structured query generated based on the refined prompt and the structured query template may be “SELECT revenue FROM financial_reports WHERE company_name=‘Acme Corp’ AND report_date BETWEEN ‘2023 Jan. 1’ AND ‘2023 Dec. 31’;”.

The query execution module 314 may then execute the structured query to retrieve structured data from a memory system (e.g., knowledge database). For instance, if the structured query is “SELECT revenue FROM financial_reports WHERE company_name=‘Acme Corp’ AND report_date BETWEEN ‘2023 Jan. 1’ AND ‘2023 Dec. 31’;”, the retrieved structured data may be “{” company_name “: “Acme Corp”, “revenue”: 50000000, “currency”: “USD”, “year”: 2023}.”

Upon determining the structured data, an input enrichment module 416 may gather additional context by incorporating the structured data, the input prompt 402, and the context data 404 to generate the user prompt 418. The context data 404 may include chat history, user profile information, past interactions, or domain-specific knowledge, which may be used to provide additional personalization and relevance to the response. The prompt conversion server 302, upon determining the user prompt, may transmit the user prompt to a large language model hosted by the language model server 200, and receive a natural-language response to the user prompt from the language model server 200 and/or the user device. As an illustrative example, the natural language response to the input prompt “What was the revenue for Acme Corp in 2023?” may be “Acme Corp's total revenue for 2023 was $50,000,000 USD,” and with the user prompt including the context data, the natural language response may include further insights, such as “Acme Corp's total revenue for 2023 was $50,000,000 USD, which reflects a 10% increase compared to the previous year.”

In some embodiments, the prompt conversion server 302 may directly transmit the input prompt 402 and the retrieved structured data to the large language model hosted by the language model server 200. The language model server 200 may generate a natural-language response to the user prompt based on the structured data and transmit the response to the prompt conversion server 302 and/or the user device 106-116. In other embodiments, the prompt conversion server 302 may transmit the input prompt 402 and the structured query to the large language model hosted by the language model server 200. The language model server 200 may execute the structured query to retrieve structured data and generate a natural-language response based on the retrieved structured data to answer the input prompt. The language model server 200 may then transmit the response to the prompt conversion server 302 and/or the user device.

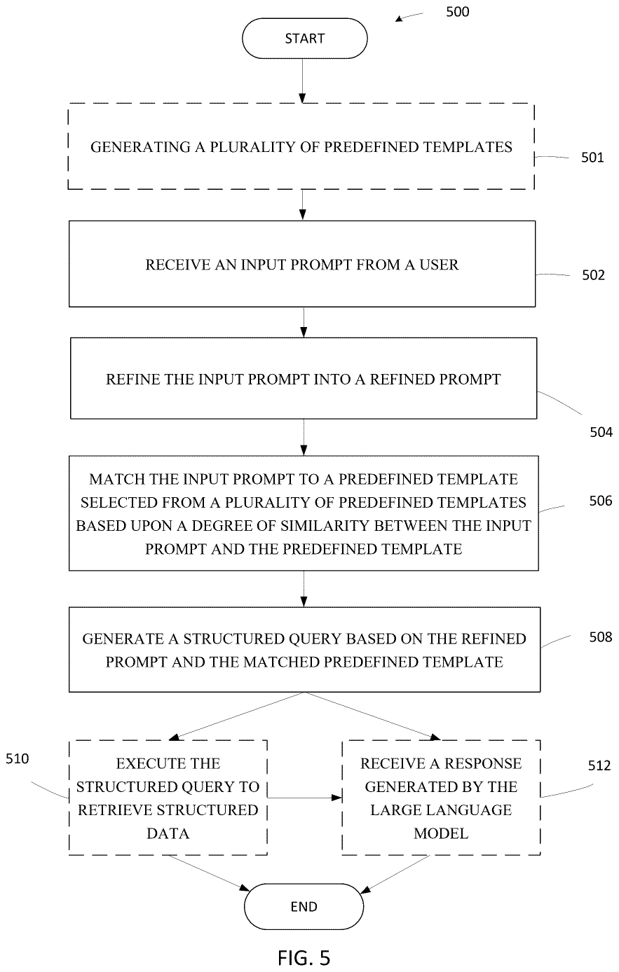

FIG. 5 illustrates an example method 500 for converting natural language input prompts into structured queries. The method can be implemented in a set of instructions stored on a computer-readable memory and executable at one or more processors of a prompt conversion server 302. A language model server 202 may include the language model used to generate the response.

At block 501, in some embodiments, the one or more processors may generate a plurality of predefined templates. Each predefined template may include a cluster of reference prompts and a structured query template associated with the cluster. The one or more processors may generate these predefined templates by using a machine learning model to analyze historical input prompts and their corresponding structured queries, identifying frequently used structured queries and designating them as structured query templates. Upon determining the structured queries, the one or more processors may utilize a large language model to generate a cluster of reference prompts that map to each structured query template, incorporating corresponding historical input prompt to the large langue model to generate the reference prompt clusters. The one or more processors may then verify the structured query templates and their associated clusters of reference prompts to ensure accuracy and consistency before finalizing them as predefined templates.

At block 502, the one or more processors may receive an input prompt from a user. The input prompt may include a natural language query. In some embodiments, the user may type the input prompt into a user interface. In further embodiments, the input prompt may be generated as a text prompt from an audio prompt spoken by a user, which audio prompt may be converted to the text prompt according to known techniques.

At block 504, the one or more processors may generate a refined prompt from the input prompt by applying one or more machine learning algorithms. In some embodiments, the one or more processors may identify one or more relevant entities within the input prompt using a first machine learning algorithm (e.g., NER algorithm). The one or more processors may then replace the one or more relevant entities with one or more placeholders. The one or more processors may then identify one or more extracted values for the one or more placeholders by applying a second machine learning (e.g., NED algorithm) algorithm to the one or more placeholders. The one or more processors may replace the one or more placeholders with the one or more extracted values to determine the refined prompt. The one or more placeholders may specify entity types corresponding to the one or more relevant entities.

At block 506, the one or more processors may match the input prompt to a predefined template selected from the plurality of predefined templates based upon a degree of similarity between the input prompt and the predefined template. Each predefined template of the plurality of predefined templates may comprise a cluster of reference prompts. In some embodiments, the one or more processors may match the refined prompt to the predefined template selected from the plurality of predefined templates based upon the degree of similarity between the refined prompt and the predefined template.

In some embodiments, the one or more processors may generate a plurality of clusters of reference prompt vectors corresponding to the plurality of predefined templates by embedding each of the plurality of clusters of reference prompts into a vector space. The one or more processors may also generate an input prompt vector by embedding the input prompt into the vector space.

In some embodiments, the one or more processors may apply a cluster quality metric to the input prompt vector and each cluster of reference prompt vectors to identify one or more similar clusters of reference prompts that exceed a cluster quality threshold. The one or more processors may then apply a machine learning classifier to the one or more similar clusters of reference prompt vectors to rank the one or more similar clusters of reference prompts. The one or more processors may match the input prompt to the predefined template comprising a highest-ranked cluster of reference prompts. In some embodiments, the cluster quality metric may be a silhouette coefficient used to determine a similarity between each cluster of reference prompt vectors and the input prompt vector.

In some embodiments, the one or more processors may determine that no cluster of reference prompt vectors meet or exceed a cluster quality threshold. The one or more processors may then match the input prompt to the predefined template indicating an absence of a valid match.

At block 508, the one or more processors may generate a structured query based on the refined prompt and the matched predefined template. Generating the structured query may include replacing variables in the structured query with values from the refined prompt.

At block 510, in some embodiments, the one or more processors may execute the structured query to retrieve structured data from a memory system (e.g., knowledge database). In various embodiments, the one or more processors may then input the input prompt and the retrieved structured data into an LLM, may store the retrieved structure data, or may present the retrieved structured data to the user.

At block 512, in some embodiments, the one or more processors may receive a response generated by the LLM. In various embodiments, the LLM may receive or may retrieve the structured data based upon the structured query. In some embodiments, the response may be generated by the LLM based on the input prompt and the structured data (from block 510). In some other embodiments, the one or more processors may input the input prompt and the structured query into a LLM. The one or more processors may then receive a response to the structured query from the LLM. In other embodiments, the one or more processors may generate a user prompt based on at least the input prompt and contextual data. The one or more processors may input the user prompt into an LLM. The one or more processors may then receive a response to the user prompt from the LLM. In various embodiments, the one or more processors may cause the response to be stored or presented to the user. The method 500 may then terminate or wait to receive a new input prompt at block 502.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for evaluating reliability of a response generated by a language model through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method for converting natural language input prompts into structured queries, the method comprising:
receiving, by one or more processors, an input prompt from a user, wherein the input prompt includes a natural language query;
generating, by the one or more processors, a refined prompt from the input prompt by applying one or more machine learning algorithms;
matching, by the one or more processors, the input prompt to a predefined template selected from a plurality of predefined templates based upon a degree of similarity indicating how well an input vector representing the input prompt fits within a cluster of reference prompts associated with the predefined template, wherein the cluster of reference prompts comprises a plurality of natural language expressions associated with a structured query format of the predefined template; and
generating, by the one or more processors, a structured query based on the refined prompt and the matched predefined template.

2. The method of claim 1, further comprising:
executing, by the one or more processors, the structured query to retrieve structured data from a memory system;
inputting, by the one or more processors, the input prompt and the retrieved structured data into a large language model; and
receiving, by the one or more processors, a response generated by the large language model based on the input prompt and the retrieved structured data.

3. The method of claim 1, further comprising:
inputting, by the one or more processors, the input prompt and the structured query into a large language model; and
receiving, by the one or more processors, a response to the structured query from the large language model.

4. The method of claim 1, further comprising:
generating, by the one or more processors, a user prompt based on at least the input prompt and contextual data;
inputting, by the one or more processors, the user prompt into a large language model; and
receiving, by the one or more processors, a response to the user prompt from the large language model.

5. The method of claim 1, wherein matching the input prompt to the predefined template selected from the plurality of predefined templates based upon the degree of similarity between the input prompt and the predefined template further comprises:
matching, by the one or more processors, the refined prompt to the predefined template selected from the plurality of predefined templates based upon the degree of similarity between the refined prompt and the predefined template.

6. The method of claim 1, further comprising:
generating, by the one or more processors, a plurality of clusters of reference prompt vectors corresponding to the plurality of predefined templates by embedding each of the plurality of clusters of reference prompts into a vector space; and
generating, by the one or more processors, the input vector by embedding the input prompt into the vector space.

7. The method of claim 6, wherein matching the input prompt to the predefined template selected from the plurality of predefined templates based upon the degree of similarity further comprises:
applying, by the one or more processors, a cluster quality metric to the input vector and each cluster of reference prompt vectors to identify one or more similar clusters of reference prompts that exceed a cluster quality threshold;
applying, by the one or more processors, a machine learning classifier to the one or more similar clusters of reference prompt vectors to rank the one or more similar clusters of reference prompts; and
matching, by the one or more processors, the input prompt to the predefined template comprising a highest-ranked cluster of reference prompts.

8. The method of claim 6, wherein matching the input prompt to the predefined template selected from the plurality of predefined templates based upon the degree of similarity further comprises:
determining, by the one or more processors, that no cluster of reference prompt vectors meet or exceed a cluster quality threshold; and
matching, by the one or more processors, the input prompt to the predefined template indicating an absence of a valid match.

9. The method of claim 1, wherein generating the refined prompt from the input prompt further comprises:
identifying, by the one or more processors, one or more relevant entities within the input prompt using a first machine learning algorithm;
replacing, by the one or more processors, the one or more relevant entities with one or more placeholders;
identifying, by the one or more processors, one or more extracted values for the one or more placeholders by applying a second machine learning algorithm to the one or more placeholders; and
replacing, by the one or more processors, the one or more placeholders with the one or more extracted values to determine the refined prompt.

10. A computer system for converting natural language input prompts into structured queries comprising:
one or more processors; and
a non-transitory program memory coupled to the one or more processors and storing executable instructions that, when executed by the one or more processors, causes the computer system to:
receive an input prompt from a user, wherein the input prompt includes a natural language query;
generate a refined prompt from the input prompt by applying one or more machine learning algorithms;
match the input prompt to a predefined template selected from a plurality of predefined templates based upon a degree of similarity indicating how well an input vector representing the input prompt fits within a cluster of reference prompts associated with the predefined template, wherein the cluster of reference prompts comprises a plurality of natural language expressions associated with a structured query format of the predefined template; and
generate a structured query based on the refined prompt and the matched predefined template.

11. The computer system of claim 10, wherein the executable instructions, when executed by the one or more processors, further cause the computer system to:
execute the structured query to retrieve structured data from a memory system;
input the input prompt and the retrieved structured data into a large language model; and
receive a response generated by the large language model based on the input prompt and the retrieved structured data.

12. The computer system of claim 10, wherein the executable instructions, when executed by the one or more processors, further cause the computer system to:
input the structured query into a large language model; and
receive a response to the structured query from the large language model.

13. The computer system of claim 10, wherein the executable instructions, when executed by the one or more processors, further cause the computer system to:
generate a user prompt based on the structured query and contextual data;
input the user prompt into a large language model; and
receive a response to the user prompt from the large language model.

14. The computer system of claim 10, wherein the executable instructions matching the input prompt to the predefined template selected from the plurality of predefined templates based upon the degree of similarity between the input prompt and the predefined template further cause the computer system to:
match the refined prompt to the predefined template selected from the plurality of predefined templates based upon the degree of similarity between the refined prompt and the predefined template.

15. A non-transitory computer-readable medium storing executable instructions for converting natural language input prompts into structured queries that, when executed by one or more processors, cause the one or more processors to:
receive an input prompt from a user, wherein the input prompt includes a natural language query;
generate a refined prompt from the input prompt by applying one or more machine learning algorithms;
match the input prompt to a predefined template selected from a plurality of predefined templates based upon a degree of similarity indicating how well an input vector representing the input prompt fits within a cluster of reference prompts associated with the predefined template, the cluster of reference prompts comprises a plurality of natural language expressions associated with a structured query format of the predefined template; and
generate a structured query based on the refined prompt and the matched predefined template.

16. The non-transitory computer-readable medium of claim 15,
wherein the executable instructions further cause the one or more processors to:
generate a plurality of clusters of reference prompt vectors corresponding to the plurality of predefined templates by embedding each of the plurality of clusters of reference prompts into a vector space; and
generate the input vector by embedding the input prompt into the vector space.

17. The non-transitory computer-readable medium of claim 16,
wherein the executable instructions that cause the one or more processors to match the input prompt to the predefined template selected from the plurality of predefined templates based upon the degree of similarity further cause the one or more processors to:
apply a cluster quality metric to the input vector and each cluster of reference prompt vectors to identify one or more similar clusters of reference prompts that exceed a cluster quality threshold;
apply a machine learning classifier to the one or more similar clusters of reference prompt vectors to rank the one or more similar clusters of reference prompts; and
match the input prompt to the predefined template comprising a highest-ranked cluster of reference prompts.

18. The non-transitory computer-readable medium of claim 16, wherein the executable instructions that cause the one or more processors to match the input prompt to the predefined template selected from the plurality of predefined templates based upon the degree of similarity further cause the one or more processors to:
determine that no cluster of reference prompt vectors meet or exceed a cluster quality threshold; and
match the input prompt to the predefined template indicating an absence of a valid match.

19. The non-transitory computer-readable medium of claim 15, wherein the executable instructions that cause the one or more processors to generate the refined prompt from the input prompt further cause the one or more processors to:
identify one or more relevant entities within the input prompt using a first machine learning algorithm;
replace the one or more relevant entities with one or more placeholders;
identify one or more extracted values for the one or more placeholders by applying a second machine learning algorithm to the one or more placeholders; and
replace the one or more placeholders with the one or more extracted values to determine the refined prompt.

20. The non-transitory computer-readable medium of claim 19, wherein the one or more placeholders specify entity types corresponding to the one or more relevant entities.
